(19) United States
(12) Patent Application Publication
(10) Pub. No.: US 2005/0031278 A1
(43) Pub. Date: Feb. 10, 2005

(54) Near-field sub-wavelength apertures

(76) Inventors: Xiaolei Shi, Niskayuna, NY (US); Lambertus Hesselink, Atherton, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/845,781

(22) Filed: May 14, 2004

Related U.S. Application Data
(60) Provisional application No. 60/471,299, filed on May 16, 2003.

(51) Int. Cl. G02B 6/04

(52) U.S. Cl. 385/121

(57) ABSTRACT

Near-field sub-wavelength C-apertures provide enhanced spatial resolution and power throughput by increasing the normalized resonant wavelength of the aperture. These improved apertures are characterized by the use of improved geometric proportions for C-apertures, filling the aperture with high-index material, designing aperture thickness to produce longitudinal transmission resonance, and/or tapering the aperture in the longitudinal direction to achieve impedance matching. Apertures according to the present invention may be used for many technological applications in various portions of the electromagnetic spectrum. Exemplary applications to high density optical data storage and optical particle trapping and manipulation are described.

### CROSS-REFERENCE TO RELATED APPLICATIONS

This application claims priority from U.S. provisional patent application No. 60/471,299 filed May 16, 2003, which is incorporated herein by reference.

### FIELD OF THE INVENTION

The present invention relates generally to devices and methods for improved near-field transmission of electromagnetic waves. More specifically, it relates to resonant transmission through sub-wavelength apertures to provide high spatial resolution and high power throughput in the near field.

### BACKGROUND OF THE INVENTION

In many technological areas it is desirable to be able to transmit electromagnetic energy with very high spatial resolution. At far-field distances from an electromagnetic wave source, the spatial resolution of the radiation is theoretically limited by the diffraction limit. Specifically, an electromagnetic wave of wavelength λ can resolve two objects in the far field only if they are spatially separated by at least λ/(2n sin(θ)), where n is the refractive index of the medium in which the objects are embedded and θ is the maximum power collection angle of the imaging system. This theoretical limit, however, only applies to far-field distances from the source, i.e., at distances greater than about λ/2. At near-field distances, it is theoretically possible for the spatial resolution to exceed the diffraction limit.

One approach to achieve high spatial resolution beyond the diffraction limit is shown in FIG. 1. This approach uses a circular aperture 100 in a thin metallic plate 102 exposed to incident linearly polarized light 104, where the aperture width w is much smaller than the wavelength λ of the light. Although this aperture can provide sub-wavelength resolution at near-field distances, it suffers from extremely low power transmission. In contrast to large apertures (w>>λ) where the power throughput (PT) is almost 100%, these sub-wavelength apertures (w<<λ) have a power throughput proportional to the fourth power of the aperture size, i.e., PT∞(W/λ)⁴. Consequently, these conventional circular sub-wavelength apertures suffer from a trade-off between spatial resolution (small w) and power throughput (large PT). Other known probe designs, such as tapered fiber probes, also suffer from this problem with low power transmission.

A new sub-wavelength aperture design having improved performance is described in international publication WO 01/17079 A1, which is incorporated herein by reference. This publication describes an aperture geometry having at least one protrusion extending into the aperture. For example, a single protrusion creates a C-shaped aperture. It is generally stated that, preferably, the geometry is adjusted to maximize desirable properties such as total field intensity and near field localization of optical power. No specific teachings are provided, however, regarding how such an optimization can be performed. The joint maximization of two or more parameters with respect to unlimited geometric possibilities is an extremely complex problem, even with computational simulations. Clearly, it would be an advance in the art to provide a single criterion for simultaneously maximizing both spatial resolution and power throughput, and to provide more exact methods for optimizing C-aperture geometries. It would also be an advance in the art to provide entirely new features in addition to geometrical aperture shape that provide additional improvements in performance.

### SUMMARY OF THE INVENTION

Building on the initial discovery of C-apertures, the present invention provides improvements in the design and function of C-apertures, as well as a deeper understanding of their properties. The present inventors have developed a numerical method for C-aperture optimization. These optimized C-apertures have improved performance in both transmission efficiency and spatial resolution as compared to prior C-aperture designs. In one aspect of the invention, these optimized C-apertures are designed by selecting the aperture geometry so that it resonates at a larger normalized resonant wavelength. The normalized resonant wavelength is defined as the ratio of the resonant wavelength to the aperture size. The inventors have also discovered that filling the aperture with high refractive index material can red-shift the resonant wavelength of the aperture and thus can achieve even higher spatial resolution.

In another aspect, the inventors have discovered that, unlike other very small apertures, the high transmission through the C-aperture does not decay with aperture metal thickness. This means that, in the case of a metal film with thickness not negligible compared to wavelength, the transmission enhancement through the C-aperture is even higher than the factor of 1000 enhancement in a very thin metal plate case. Furthermore, the resonant transmission may be further enhanced when the aperture metal thickness is designed properly to achieve a Fabry-Perot-like resonance from constructive front and back interface reflections.

The inventors have also discovered that, for metals with finite losses, the high transmission performance may be maintained by reducing the corresponding aperture size to compensate for the finite penetration depth of the metal.

Those skilled in the art will appreciate that, while the C-apertures may be designed and described for optical frequency ranges, the principles of the invention are of general application to other frequencies. For example, the same aperture geometry can be applied to other electromagnetic frequencies such as microwave, THz, and infrared ranges. The aperture geometry in each case is simply scaled according to the corresponding application wavelength. Thus, the scope of the invention is not limited to apertures for use in optical frequency ranges.

### BRIEF DESCRIPTION OF THE DRAWINGS

FIG. 1 illustrates a conventional sub-wavelength circular aperture in a thin metallic plate exposed to linearly polarized light.

FIG. 2 shows the parameters defining the geometry of a C-aperture according to an embodiment of the present invention.

FIG. 3 is a graph illustrating the power throughput of square, rectangular, and C-apertures, illustrating the principle that higher performance apertures have higher normalized resonant wavelength.

FIG. 4 is a graph showing how the spectral response of C-apertures changes as the thickness of the aperture metal plate increases.

FIG. 5 is a graph illustrating the presence of a transmission resonance with periodic peaks at different values of the metal thickness.

FIG. 6 is a cross-section of an aperture in a plate of thickness t, illustrating the principle behind the transmission resonance effect shown in FIG. 5.

FIG. 7 illustrates an aperture filled with a high index material according to an embodiment of the invention.

FIG. 8 is a graph showing the frequency response curves for a C-aperture with a glass filling and without a glass filling.

FIG. 9 shows a C-aperture design that includes a substrate medium upon which the metal and aperture filling layers are deposited.

FIG. 10 illustrates a C-aperture that is tapered in the thickness dimension t to provide impedance matching, according to an embodiment of the invention.

FIG. 11 illustrates an aperture design according to an embodiment of the present invention, including two back-to-back C-apertures.

FIG. 12 illustrates the compound aperture of FIG. 11 being used to trap a small particle of diameter d.

FIG. 13 shows a tapered fiber probe fabricated with a C-aperture at the output end, according to an embodiment of the present invention.

FIG. 14 shows a very small aperture laser fabricated with a C-aperture for use in a high density optical data storage device, according to an embodiment of the present invention.

### DETAILED DESCRIPTION

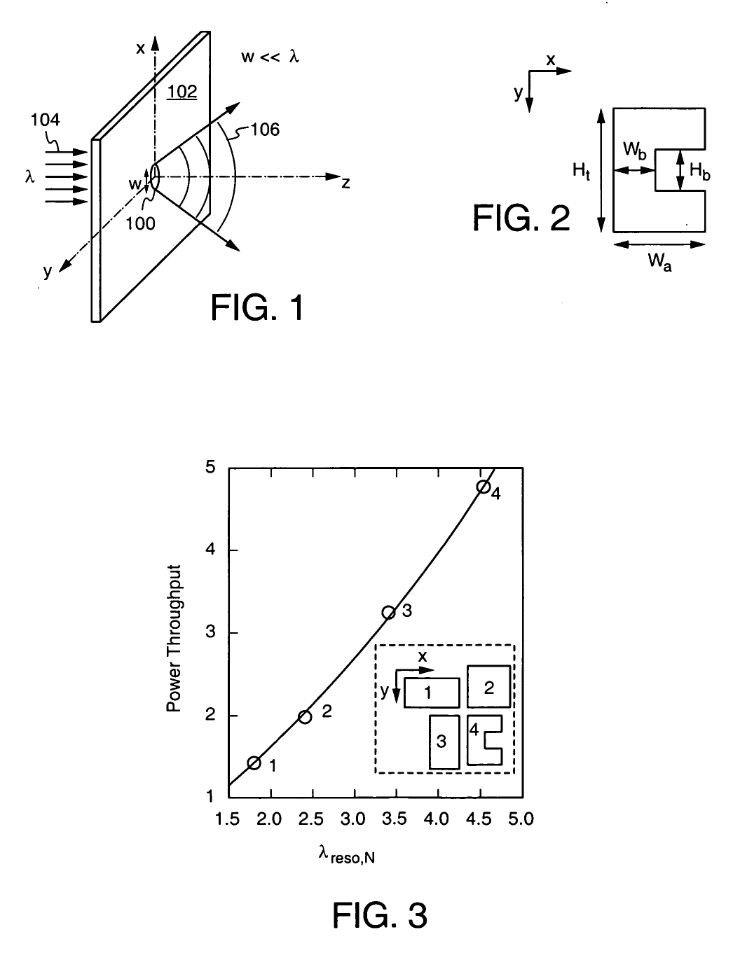

The description of the present invention and its various embodiments is best understood by first defining certain technical terms that pertain generally to sub-wavelength apertures, such as the aperture shown in FIG. 1. An planar aperture is defined as an opening 100 in a locally planar surface 102 that allows radiation 104 incident on one side of the surface to pass from one side of the surface to the other, resulting in the transmission of radiation 106 through the aperture. The transmission cross-section σ₁ is defined as the ratio of the total transmitted power Pₜᵣₐₙₛ to the incident power flux density S_{inc}, i.e., σ₁=Pₜᵣₐₙₛ/S_{inc}. The power throughput is defined as PT=σ₁/A, where A is the aperture area. Without loss of generality, the coordinate system used in this description is selected so that the radiation 104 incident on the aperture propagates in the z direction, the x-y plane coincides with the plane 102 of the aperture, and the origin is located at the center of the aperture 100. The wavelength of incident radiation is denoted λ, and the aperture width is denoted w for circular or square apertures. A large aperture refers to the case where w>5λ. A small aperture refers to the case where w<<λ/2. An resonant aperture refers to an intermediate aperture size between these two extremes. A sub-wavelength aperture refers to an aperture where w<λ. For sub-wavelength apertures, the very near field region refers to the region where z<λ/2, the far field region refers to the region where z>λ/2, and the intermediate field region refers to the region between these extremes where w/2<z<λ/2. In the very near field region the electromagnetic field intensity is confined to a size about equal to the aperture size. In the far field region the field intensity drops as 1/z².

In one aspect of the invention, computational simulations are used to study the near-field transmission of electromagnetic waves through apertures, and to optimize aperture design. In one embodiment, the computational simulation uses the finite difference time domain (FDTD) method, which is a well-known numerical method for rigorously solving Maxwell's equations. Given a characterization of the incident radiation field and the geometric and material properties of the interacting structures in the environment, the FDTD method accurately provides complete information about the electric and magnetic field components at any point in space and time. The commercially available software package XFDTD pro, for example, may be used to implement to FDTD method. To reduce numerical errors, it is preferred to 1) select the time step Δt to satisfy the Courant condition, (cΔt)²≦(1/Δx)²+(1/Δy)²+(1/Δz)², where Δx, Δy, Δz are the grid sizes in the x, y, z directions, and 2) select Δx, Δy, Δz≦L/20, where L is the smaller of the wavelength in the highest index medium present and the smallest length defined in the interacting structure. In the FDTD method, metals may be simulated using four parameters (ε_{dc}, ε_{∞}, σ, τ). These parameters specify the static permittivity, the infinite frequency permittivity, the conductivity, and the relaxation time, respectively, of the metal.

The simulations preferably model incident light as a plane wave or Gaussian mode wave linearly polarized in the x-direction, i.e., polarized in the horizontal direction when the aperture is oriented to appear like the upright letter C. To determine an aperture's resonant transmission wavelength, it is preferred to model the incident radiation as a short plane wave pulse. During the simulation process, electromagnetic field values in the transmission region are recorded at several locations. Fourier transforms are performed for both the incident pulse and the measured transmission fields to obtain both the incident field spectrum and the transmission field spectrum. By normalizing the transmission field spectrum to the incident field spectrum, a response spectrum is obtained at each location. The peak location in the response spectrum determines the resonant transmission frequency. The resonant transmission wavelength λᵣₑₛₒ can be calculated from this frequency. The resonant transmission power throughput can be obtained by performing another simulation using an incident monochromatic wave at the resonant wavelength λᵣₑₛₒ, The advantage of using an incident pulse in the initial simulation is that the resonant transmission wavelength can be determined from a single simulation, which is more computationally efficient than performing a simulation at each wavelength.

Prior understanding of conventional square apertures was limited to the very small and very large aperture cases (i.e., w<<λ and w>>λ). The inventors have discovered surprising properties of apertures whose width is an intermediate size between these extremes.

Geometry Effect

Changes in aperture geometry profoundly affect transmission efficiency through the aperture. However, it is not initially obvious how to select a geometry to optimize power throughput and localization of high intensity peaks (i.e., spatial resolution). Further investigation with square and rectangular apertures shows that aperture transmission is strongly correlated with aperture size in the direction perpendicular to the incident polarization and is much less correlated with aperture size in the direction parallel to the incident polarization. Increasing an aperture's size in the direction perpendicular to the incident light polarization increases its transmission efficiency and its near field intensity. Reducing an aperture's size in the direction parallel to the incident light polarization helps to reduce the near field spot size and does not affect its transmission efficiency much. For near field applications, vertically oriented rectangular apertures are better than square apertures. These observations provide guidance in optimizing aperture geometry, such as an aperture whose geometry has the shape of a letter C, i.e., a C-aperture.

As shown in FIG. 2, geometrical parameters of a C-aperture can be defined by four linear lengths: the total horizontal extent Wₐ, the total vertical extent Hₜ, the vertical gap H_{b} between the two arms, and the horizontal width W_{b} of the vertical waist connecting the two arms. A known C-aperture design has the following relative dimensions: W_{b}=H_{b}, Wₐ=2.2W_{b}, and Hₜ=3H_{b}. The arms in this design have equal height (Hₜ−H_{b})/2. This C-aperture design (called C1) has resonant transmission at a wavelength λ=10W_{b}=10H_{b}. For example, to design such a C-aperture that resonates at λ=1000 nm, one sets W_{b}=H_{b}=100 nm, Wₐ=220 nm, and Hₜ=300 nm. A high intensity field is produced at about z=50 nm=λ/20 from the aperture plane, centered along the inner vertical edge of the C with a full width half maximum (FWHM) of 128 nm in the x-direction and 136 nm in the y-direction. The power throughput is 4.41, which is about 1000 times larger than that of a square aperture with w=100 nm.

The inventors have discovered even higher performance C-aperture designs. In particular, simulations were used to find the geometric dimensions for a C-aperture that optimizes its performance. This optimization is based in part on the following novel insights. Apertures with the same area but different geometries may resonate at different wavelengths. Thus, for an aperture with area A, we define the normalized resonant wavelength to be the resonant wavelength normalized by the aperture size, i.e., λ_{reso,N}=λᵣₑₛₒ/A^{1/2}. For apertures with a same resonant wavelength, the near field spatial resolution is proportional to the corresponding normalized resonant wavelength, i.e., the higher the normalized resonant wavelength, the higher the near-field spatial resolution. Comparing square, rectangular, and C-apertures, it is found that the aperture geometries with higher power throughput also have higher normalized resonant wavelength, as illustrated in FIG. 3. Thus, preferred aperture geometries correspond to apertures with high normalized resonant wavelength. This provides a criterion to guide a search for optimal aperture designs for high transmission, high spatial resolution applications. (It should be noted that the polarization effect mentioned earlier is also illustrated in FIG. 3 by the power throughput difference between the two rectangular apertures.)

Moreover, there are several other important observations that provide guidance for “C”-aperture design optimization.

1. The near field spot size. The near field spot from a C-aperture is mostly concentrated along the inner edge of the aperture waist around the C-aperture center. This implies that a smaller near field spot size may be achieved (at a closer distance from the aperture) by reducing the waist height and width.

2. The resonant transmission wavelength. An aperture with a longer resonant transmission wavelength may provide both higher spatial resolution and higher resonant transmission efficiency.

3. The resonant wavelength curve. A C-aperture's resonant wavelength changes as the aperture's geometry is tuned. The resonant wavelength of a C-aperture (FIG. 2) is much more sensitive to changes of Wₐ and W_{b} than that of H_{b} and Hₜ. By increasing Wₐ or decreasing W_{b}, the resonant wavelength can be red-shifted.

Combining these guidelines, reducing the relative lengths of both H_{b} and W_{b} is beneficial for achieving both higher spatial resolution and a longer resonant wavelength. With this insight, a second C-aperture design (called C₂) was developed. The relative dimensions of the C2 design are: H_{b}=W_{b}, Hₜ=4.2H_{b}, Wₐ=4.4W_{b}. For example, with H_{b}=W_{b}=50 nm, the other parameters are Hₜ=210 nm and Wₐ=220 mm. At 48 nm away from the aperture, C2 shows a more than two times higher near field intensity than that of C1. In addition C2 has a spot size about 30 nm smaller than that of C1 in the y-direction. The spot size in the x-direction is about the same. For C2, a fairly well-defined spot is formed at 24 nm away from the aperture. The field intensity at this location is about 4 times higher than that at 48 nm away. The near field spot size at 24 nm away is greatly reduced as well, which is about 50 nm smaller in the x-direction and about 25 nm smaller in the y-direction than that at 48 nm away.

The C2 design suggests that reducing the C-aperture's relative dimensions in the y-direction is helpful for achieving higher spatial resolution. Based on this observation, another C-aperture design (called C3) was developed. The relative dimensions of the C2 design are: H_{b}=W_{b}, Hₜ=3H_{b}, Wₐ=5W_{b}. For example, with H_{b}=W_{b}=48 nm, the other parameters are Hₜ=144 nm and Wₐ=240 nm. At 48 nm away from this aperture, there is more than three times higher peak intensity than that of C1, and it is also higher than that of C2. The spot size from C3 is significantly smaller than that of C1 as well and it is also a little smaller than C2 in the y-direction. Similar to C2, at 24 nm away from the aperture, C3 has a well-defined spot. At this location, the spot size is smaller in the y-direction but a little larger in the x-direction than that of C2. The size reduction in the y-direction seems related to a shorter total aperture height Hₜ. A little increase in x might be related to a longer Wₐ in C3. A further spot size reduction in the x dimension may be achieved by reducing W_{b}. Of course, in the C3 case, at a closer distance to the aperture, an even smaller spot size should be expected.

In comparing C1, C2 and C3, it is interesting to observe that the aperture physical area is decreasing while the resonance power throughput is increasing, the resonance width is decreasing, and the transmission resonance is getting sharper and sharper. This is a further demonstration of the general guideline for aperture optimization: the higher the normalized resonant wavelength, the higher the spatial resolution and the power throughput. (In general, the upper limit of a resonant transmission cross-section σₜ is about (λᵣₑₛₒ)².)

Thus, in general the following numerical method for C-aperture optimization may be used. To find the optimal C-aperture geometry, the normalized resonant wavelength λ_{reso,N} can be maximized with respect to the four geometric parameters Wₐ, Hₜ, H_{b}, and W_{b}. Optimizing the normalized resonant wavelength for a specific application will result in a C-aperture geometry that has high performance in terms of both spatial resolution and power throughput. The single normalized resonant wavelength variable thus provides an efficient way to simultaneously optimize two desirable C-aperture properties.

Thickness Effect

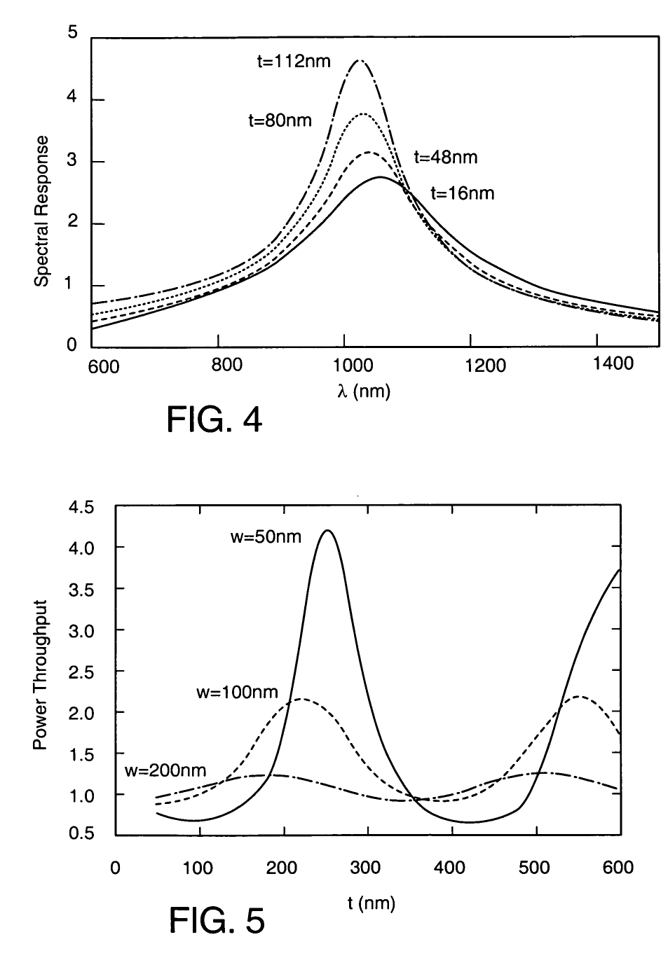

Prior theoretical models of sub-wavelength apertures assume the metal plate thickness t is negligible compared to the wavelength (i.e., t<<λ). At optical wavelengths, however, this approximation is not always practical to realize. Consequently, prior knowledge of transmission through apertures in plates with non-negligible thickness has been limited. For example, it has been assumed that, for small apertures, both power throughput and near field intensity drop as thickness increases. The present inventors have verified this assumption for small square apertures. Surprisingly, however, for C-apertures the inventors have discovered that the power throughput remains high as thickness increases, and there is also a slight blue-shifting and a narrowing of the spectral response, as shown in FIG. 4. In fact, the peak spectral response is higher as thickness increases.

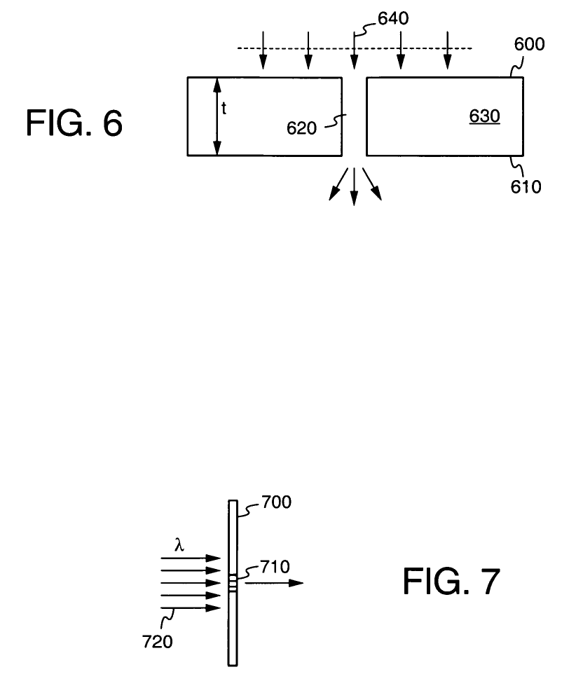

Moreover, simulations of transmission of polarized radiation through narrow slits oriented perpendicular to the polarization direction show that additional transmission resonance associated with the metal thickness may be produced. As shown in FIG. 5, this kind of resonance appears periodically as the metal thickness continuously increases, with the resonance becoming weaker and weaker as thickness increases due to power losses in the metal. The resonant peaks appear at multiple thicknesses separated by about half the wavelength. Thus, longitudinal resonance happens when t is an integral multiple of λᵣₑₛₒ/2. For example, a 100 nm slit exposed to 658 nm incident radiation has transmission resonance peaks at thicknesses of 220 nm and 550 nm. A 50 nm slit exposed to 658 nm incident radiation exhibits a very strong transmission resonance peak at thickness t=250 nm with power throughput over 4. The resonance effect for larger slits is not as significant. This transmission resonance effect is presumably due to constructive interference between front and back scattering fields, analogous to a Fabry-Perot effect. FIG. 6 is a cross-section of an aperture in a plate of thickness t, illustrating the principle behind this effect. As the incident radiation 640 enters the aperture 620 at the front surface plane 600 of the metal plate 630 there is front scattering. The wave then experiences mode propagation through the interior of the aperture 620, which behaves like a waveguide of length t. At the back surface plane 610 of the plate 630 the wave exits the aperture 620 and experiences back scattering. Interference between the front and back scattering in the longitudinal direction produces periodic longitudinal resonance of period equal to about λ/2.

Finite Conductivity Effects

At microwave and infrared wavelengths, metals are well approximated as perfect conductors. At optical wavelengths, however, the finite conductivity can have a significant effect. In particular, because the waves penetrate into the metal by roughly a skin depth, the aperture is effectively larger than its physical size, resulting in an increase in the spot size. The C-aperture geometry can still be appropriately optimized using the optimization techniques discussed earlier. In general, the optimized C-aperture in a lossy metal has a geometry smaller than its perfect conductor counterpart by roughly a size of the skin depth. For example, a fourth C-aperture design (called C4) was developed with H_{b}=W_{b}=60 nm, Hₜ=260=m, and Wₐ=100 nm to have resonant transmission at 1 μm in a silver plate. The power throughput from this C-aperture is 2.2, the near field spot size (FWHM) is 115 nm by 130 nm, near field peak intensity is 7.42, as measured at 50 nm away from the aperture.

Because metallic nano-structures show plasmon resonance at optical frequencies, a further enhancement of transmission may be realized by aligning the resonance wavelength of the local surface plasmon with the resonance wavelength of the aperture transmission.

Refractive Index Effect

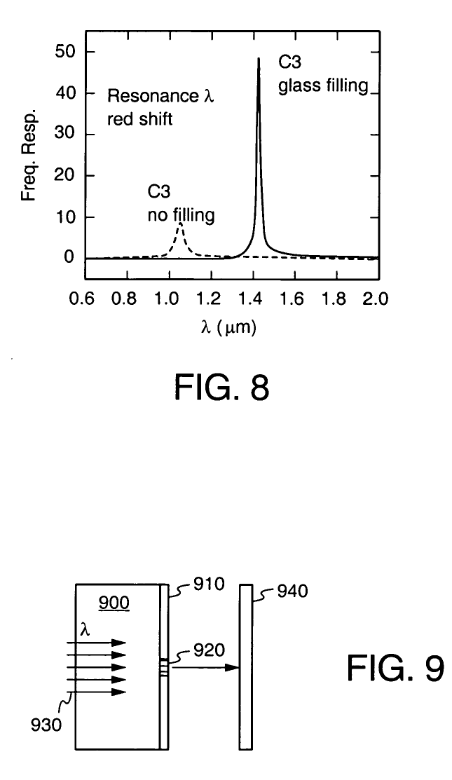

In addition to geometry, the inventors have discovered another way to achieve a higher spatial resolution: inserting a high refractive index material in the aperture. In a medium with refractive index n, the light wavelength is reduced by a factor of n. Therefore, the aperture size could be scaled down by the same factor and the near-field spot size can be scaled down (i.e., near-field spatial resolution is scaled up) as well. FIG. 7 illustrates an aperture 710 in a metal plate 700, where the aperture 710 is filled with a high index material (e.g., glass or other dielectric). Incident radiation 720 of wavelength λ enters the aperture and its wavelength is effectively reduced by a factor n. Consequently, the aperture optimization in this case will result in smaller dimensions and a higher spatial resolution. For example, as shown in FIG. 8, for the C3 design filled with glass (n=1.5), the resonant transmission wavelength red-shifts by a factor of about 1.4, which is close to the glass refractive index. The red-shift of the resonant wavelength implies that higher spatial resolution can be achieved using this modification. FIG. 8 also shows that the frequency response increases. Because the resonant wavelength increases, the normalized resonant wavelength also increases, which implies increased overall performance.

Media Effect

In optical applications, it can be difficult to fabricate a free-standing metal aperture plate whose thickness is smaller than the wavelength. Thus, as shown in FIG. 9, it can be of practical benefit to include a substrate medium 900 upon which the metal 910 and aperture filling 920 is deposited. In such aperture designs, the substrate is on the incident radiation side of the aperture, providing free space in front of the aperture for the radiation 930 to usefully interact with target objects 940. The presence of the substrate medium results, however, in a media effect on the transmission. The effect of the media is to effectively decrease the wavelength of the radiation from λ to λ/n, where n is the refractive index of the medium. To compensate for this effect, the aperture geometry can be scaled down by a factor of approximately n and its parameters optimized. The apertures of the present invention may also be fabricated in dielectric media or nonlinear media.

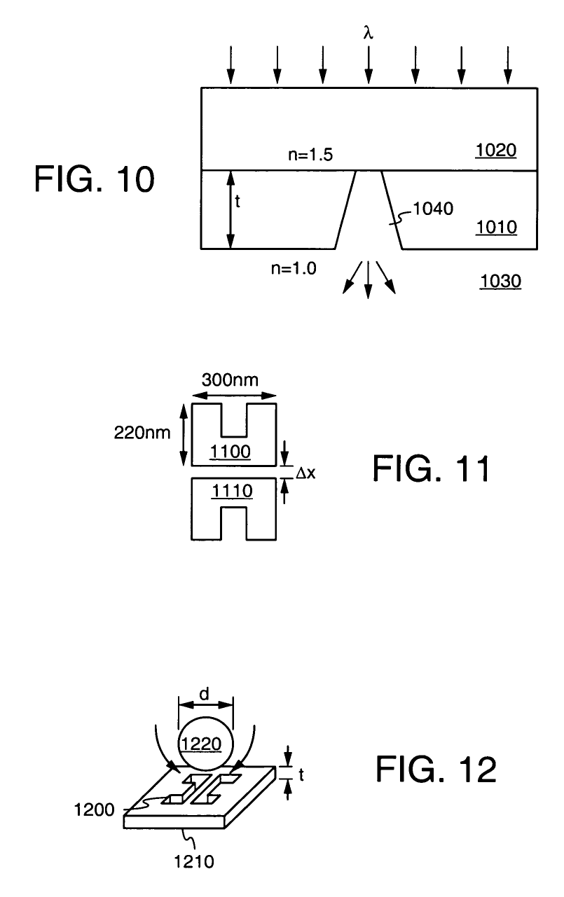

FIG. 10 illustrates a C-aperture that is tapered in the thickness dimension t, while maintaining its geometry in the transverse dimensions. (Note that this cross-sectional view does not show the C-aperture shape that would be seen in a top view.) This tapering can modify the effective impedance of the aperture through the thickness. This provides a way to impedance match the aperture with its front, back interface materials (if they have different index) and its filling material to further improve the power throughput efficiency. As the effective wavelength is decreased in a high refractive index material, in general, the aperture size should be scaled down at the end where the interface material has a higher index and should be scaled up at the end where the interface material has a lower index. Thus, FIG. 10 shows a tapering of the aperture 1040 in the metal layer 1010 outward from a high index substrate 1020 to the lower index air 1030.

Multiple C-Apertures

Multiple apertures of the present invention may be used together for producing multiple spots at separated distances, or to produce a compound aperture of mutually interacting single apertures. For example, a 1D or 2D array of C-apertures of similar size and geometry arranged with the same or differing orientations can be used for parallel nano-lithography applications. As another example, FIG. 11 illustrates an aperture design including two back-to-back C-apertures 1100 and 1110 separated by a distance Ax. This type of compound aperture can be used for three-dimensional sub-diffraction limited optical trapping (compared to two-dimensional sub-diffraction limited trapping from a single C-aperture) of very small particles, e.g., particles having diameters from 50 nm to 600 nm. FIG. 12 illustrates such an aperture 1200 formed in a metal plate 1210 of thickness t used to trap a small particle 1220 of diameter d. This strong local field of the C-aperture makes its particle trap force more than 100 times greater than the force of a trap using a conventional square aperture. Thus, it is strong enough to overcome the Brownian random motion of the particle.

C-APERTURES WITH TAPERED FIBERS

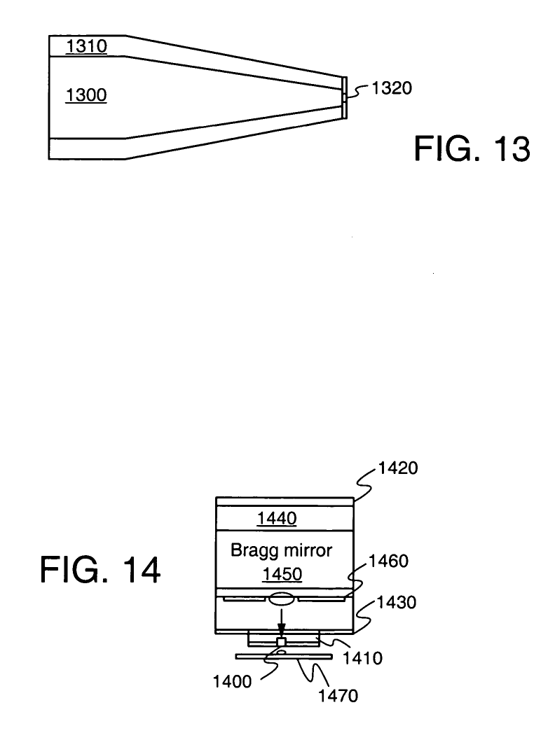

Another type of sub-wavelength aperture design is the tapered fiber aperture. Such a device can be fabricated with a C-aperture at the output end, as illustrated in FIG. 13, which provides enhanced convenience and flexibility for applications such as high resolution optical endoscopes, near-field data storage, or as an efficiency power coupler for photonic crystal devices. The fiber 1300 may have a metal coating 1310 and may be tapered toward the aperture end, as with a conventional tapered fiber probe. At the output end, however, a C-aperture 1320 is fabricated. The taper and the metal coating around the probe sides may not be necessary if the probe head size and positioning control is not a concern. Transmission power can be improved without the taper and the metal coating at the side. Similarly, a C-aperture may be fabricated at the output of a pyramid probe tip with similar transmission performance improvement.

Data Storage Applications

The improved C-apertures of the present invention are valuable for various near field optical applications such as high density optical data storage, nano-scale particle manipulation, and near field optical microscopy and spectroscopy. For example, an aperture of the invention may be used in a high density optical data storage device, as illustrated in FIG. 14. A vertical small aperture laser (VSAL) is fabricated with a nano-sized C-aperture 1400 just beyond its small aperture output. A dielectric spacer 1410 is positioned between the laser cavity and the C-aperture 1400. The C-aperture preferably is filled with a high index material to increase performance. In the illustrated embodiment, the laser has an N-side contact 1420, P-side contact 1430, GaAs substrate 1440, Bragg mirror 1450, and an oxide mode confinement layer 1460. A data storage medium 1470 is positioned in the near-field region just beyond the C-aperture 1400. Because current near field probes suffer from low power transmission, they suffer from low signal to noise ratios and hence slow data transfer speeds. The performance of this data storage device is dramatically improved compared to conventional devices by using the C-aperture designs of the present invention. For examples of such small aperture lasers, see S. Shinada, F. Koyama, K. Suzuki, N. Nishiyama, K. Goto, and K. Iga, “Microaperture surface emitting laser for near field optical data storage”, in Technical Digest. CLEO/Pacific Rim '99, 30 Aug.-3 September 1999, Seoul, South Korea, (Piscataway, N. J., USA: IEEE, 1999), p.618. Also see A. Partovi, D. Peale, M. Wuttig, C. Murray, G. Zydzik, L. Hopkins, K. Baldwin, W. Hobson, J. Wynn, J. Lopata, L. Dhar, R. Chichester, and J.-J. Yeh, “Highpower laser light source for near-field optics and its application to high-density optical data storage”, Applied Physics Letters 75, 1515 (1999). It is also important to note that a C-aperture can also be used for optically assisted magnetic data storage. Another possibility is to create dynamically a C-aperture (instead of a circular aperture) in Super-RENS type of near-field data storage to enhance the light transmission through the aperture (see J. Tominaga, T. Nakano, and N. Atoda, “An approach for recording and readout beyond the diffraction limit with an Sb thin film”, in Applied Physics Letters 73, 2078 (1998)).

Fabrication Methods

C-apertures can be fabricated with focused ion beam technology or other nano-fabrication technologies (E-beam lithography, nano-imprint technology, etc). Compared with a coaxial probe or a dimple-hole array, the C-aperture is clearly easier to fabricate since it is a single planar structure. Other aperture geometries, such as doughnut-shapes, appear to be inferior to the C-aperture in both transmission efficiency and spatial confinement. I- or H-shaped apertures provide performance similar to a C-shaped aperture. A high-performance C-aperture is expected to significantly improve near-field optical applications such as optical data storage, nanolithography, and nanomicroscopy.

Other Applications

C-aperture can be used for ultra-high resolution laser machining, cutting, laser surgery. This is potentially very useful for operation on single molecules such as DNA chains, proteins, bio-tissues, etc. The highly localized and strong intensity field can also be used for local field enhanced Raman spectroscopy, local field enhanced two-photon excitation, which are extremely important for biosensor and chemical sensor applications to enhance the signal level by orders of magnitude. The high local field is also very useful for enhanced nonlinear optical efficiencies. The strong local field can also be used as a high resolution optical tweezers to manipulate single molecules. The high transmission high resolution aperture metal layer can be deposited on a medium within photonic crystal devices or other devices and used as an efficiency power coupler. A C-aperture also provides a good polarization selectivity about 1:20 at deep sub-wavelength scale, which could be very useful in an integrated optical devices within which a C-aperture is fabricated as an integrated component. A C-aperture layer may also be fabricated upon an electro-optic medium to produce an electro-optic switch. The index tuning of the electro-optic medium makes the C-aperture function as a switch due to the transmission resonance shift.

The C-apertures and their resonant-transmission properties can be scaled to other electromagnetic wavelengths. For applications in the visible spectrum, the C-apertures can be fabricated using focused ion-beam lithography or electron-beam lithography, which can provide a spatial resolution as high as about 25 nm. The C-aperture does not require any other surface structures to support resonant transmission, and the high power-transmission efficiency does not require an extended beam illumination. This makes the C-aperture highly efficient in terms of photon usage. The C-aperture can also be arranged in an array format for parallel operations. Compared with the transmission enhancement through a hole array, the single C-aperture geometry makes it much more flexible in regard to the array periodicity and array pattern. Therefore we expect C-apertures, and other single sub-wavelength apertures, to be very useful for various applications such as ultrahigh-density optical data storage, nanolithography, near-field optical probes, and nano-optical tweezers.

1. A near-field electromagnetic aperture device comprising:
a metal plate of thickness t; and
an aperture in the metal plate;
wherein the aperture has an area A and a C-shaped geometry;
wherein electromagnetic waves of wavelength λᵣₑₛₒ experience resonant transmission through the aperture; and
wherein a normalized resonant wavelength, λ_{reso,N}=λᵣₑₛₒ/A^{1/2} is maximized with respect to dimensions of the C-shaped geometry.

2. The device of claim 1 wherein the thickness t is selected to produce longitudinal resonance in the aperture at wavelength λᵣₑₛₒ.

4. The device of claim 1 further comprising a material filling the aperture.

5. The device of claim 1 wherein the aperture is tapered in the direction of the metal plate thickness.

6. The device of claim 1 further comprising an optical fiber, wherein the metal plate is attached to an output end of the optical fiber.

7. A near-field electromagnetic aperture device comprising:
a metal plate of thickness t;
an aperture in the metal plate; and
a material filling the aperture;
wherein the material has an index of refraction n;
wherein the aperture has an area A and a C-shaped geometry; and
wherein the C-shaped geometry is selected so that electromagnetic waves of wavelength λᵣₑₛₒ experience resonant transmission through the aperture.

8. The device of claim 7 wherein the thickness t is selected to produce longitudinal resonance in the aperture at wavelength λᵣₑₛₒ.

9. The device of claim 7 wherein the aperture is tapered in the direction of the metal plate thickness.

10. A near-field electromagnetic aperture device comprising:
a metal plate of thickness t; and
an aperture in the metal plate;
wherein the aperture has an area A and a C-shaped geometry; and
wherein the thickness t is selected to produce longitudinal resonance in the aperture at wavelength λᵣₑₛₒ.

11. The device of claim 9 further comprising a second C-shaped aperture in the metal plate, wherein the two apertures are positioned back-to-back.

12. The device of claim 9 further comprising an array of C-shaped apertures.

13. The device of claim 9 further comprising a tapered fiber probe having an output tip, wherein the metal plate is positioned at the output tip of the tapered fiber probe.

14. The device of claim 9 further comprising a very small aperture laser having an optical output, wherein the metal plate is positioned in front of the optical output.

15. The device of claim 9 further comprising an electro-optic material medium upon which the metal plate is deposited.

16. The device of claim 9 wherein the device is an integrated optical device structure designed for power coupling and/or for polarization selection.
